(19) United States
(12) Patent Application Publication
(10) Pub. No.: US 2016/0156837 A1
(43) Pub. Date: Jun. 2, 2016

(54) ALTERNATIVE CAMERA FUNCTION CONTROL

(71) Applicants: Alexandar Rodzevski, Lund (SE); Marcus Numminen, Lund (SE); Erik Westenius, Lund (SE); Zhong Li, Beijing (CN); Neil Gao, Beijing (CN); Hairong Huang, Beijing (CN); Hongxing Yu, Beijing (CN); Kevin Zhou, Beijing (CN); Gang Xu, Beijing (CN)

(72) Inventors: Alexandar Rodzevski, Lund (SE); Marcus Numminen, Lund (SE); Erik Westenius, Lund (SE); Zhong Li, Beijing (CN); Neil Gao, Beijing (CN); Hairong Huang, Beijing (CN); Hongxing Yu, Beijing (CN); Kevin Zhou, Beijing (CN); Gang Xu, Beijing (CN)

(73) Assignee: Sony Corporation, Tokyo (JP)

(21) Appl. No.: 14/403,307

(22) PCT Filed: Mar. 31, 2014
(86) PCT No.: PCT/IB2014/060311

§ 371 Date: Nov. 24, 2014

(30) Foreign Application Priority Data
Dec. 24, 2013 (CN) 201310722430.X

(51) Int. Cl. H04N 5/232; G06F 3/01; G06F 3/0485; G06F 3/0482; G06F 3/0484

(52) U.S. Cl. CPC H04N 5/23216; G06F 3/0482; G06F 3/04842; G06F 3/0485; G06F 3/017

(57) ABSTRACT

A device and method is provided for controlling a electronic device that includes a display device arranged on a first side of the electronic device, and a first optical device configured to capture optical data. An object is placed over the first optical device so as to at least partially block ambient light from the first optical device, and based on data captured by the first optical device, an input to the electronic device is assigned to the detected object. The assigned input is equated to a predetermined function of the electronic device.

### TECHNICAL FIELD

The technology of the present disclosure relates generally to electronic devices and, more particularly, to an apparatus and method for providing alternative inputs to an electronic device

### BACKGROUND ART

Electronic devices, such as mobile phones, cameras, music players, notepads, etc., are becoming increasingly popular. For example, mobile telephones, in addition to providing a means for communicating with others, provide a number of other features, such as text messaging, email, camera functions, the ability to execute applications, etc.

A popular feature of electronic devices, such as mobile telephones, is their ability to take photographs. With the ever advancing quality of photographic images produced by portable electronic devices, users no longer need to carry a separate “dedicated” camera to capture special moments.

To capture an image using an electronic device, a user simply points the electronic device at the object to be photographed and presses a button (e.g., a shutter button), which instructs the electronic device to capture the image. Initially, shutter buttons were implemented in electronic devices as mechanical buttons, e.g., a button that is physically displaced. With the advent of touch screens, many electronic devices implement so called “soft” shutter buttons, which map a touch zone on the display to a shutter button function.

Also, to assist in navigating between various menus and/or to locations on a display screen, a simulated navigational function often is implemented in electronic devices, where a user may swipe up/down/left/right on a touch screen to simulate actions previously implemented using a navigational pad. By detecting touch events over a plurality of sequential touch zones, navigation commands can be inferred.

Thus, for example, a user can open a “Settings” menu via soft button on the touch screen (e.g., press/release event). The user than can navigate within the Settings menu using the simulated navigational pad functionality.

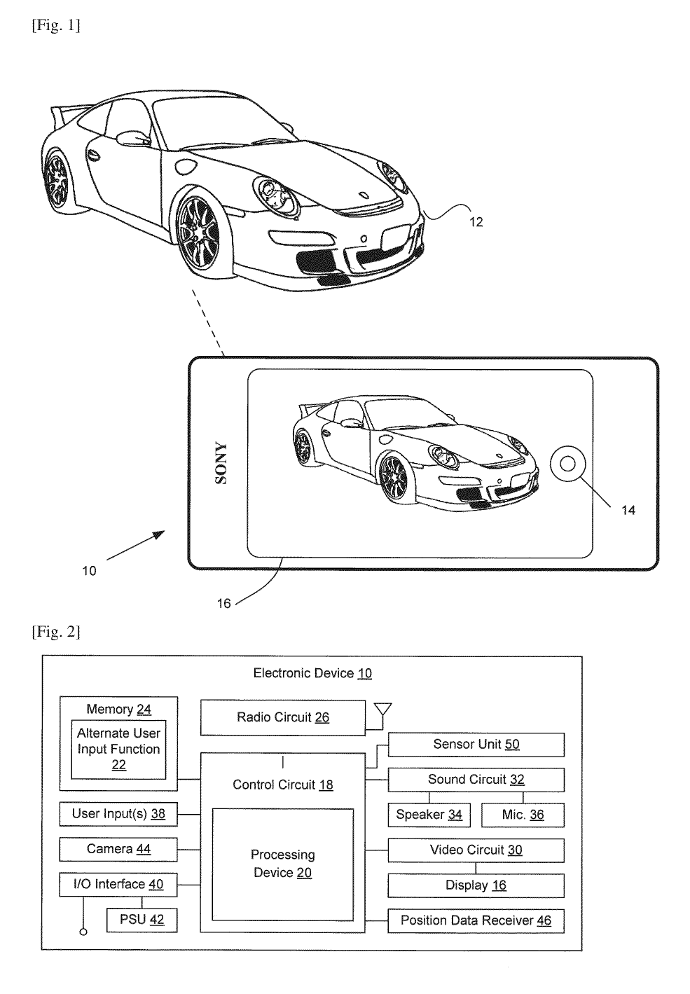

For example, FIG. 1 illustrates a conventional electronic device in the form of a mobile telephone 10, the mobile telephone being in camera mode. To capture an image, a user points the mobile telephone at an object 12, and then touches a soft shutter button 14 on a display 16 of the electronic device 10. Upon touching the soft shutter button 14, the mobile telephone 10 stores an image obtained via camera optics (not shown) in memory of the phone.

### SUMMARY

Many manufacturers of portable electronic devices offer water proof models, and the popularity of such water proof models is increasing. Surprisingly, only a few models actually have a mechanical shutter button for capturing images and/or a mechanical navigational pad for navigating within menus, etc. The lack of a mechanical shutter button and/or a mechanical navigational pad can make the underwater picture taking process a bit tricky, since touch screens typically do not work underwater.

One approach to overcoming the above limitation is to capture an image at certain time intervals. A problem with this approach, however, is that one may desire to capture a specific moment in time, and the “interval” on the electronic device may not correspond to that specific moment in time. Moreover, such “time interval” approach does not address the lack of navigational pad functionality.

In accordance with the present disclosure a means is provided for user interface operations on an electronic device in situations where a touch screen is inoperative, e.g., when the electronic device is underwater, wet, or broken, or simply when an alternative input means to the touch screen is desired.

According to another aspect of the disclosure, a press and/or release event, such as a camera shutter button function, can be realized by shielding the camera optics for a predetermine length of time and then exposing the camera optics.

According to another aspect of the disclosure, a press and/or release event, such as a camera shutter button function, and/or a navigation function, e.g., a motion command such as a scroll function, can be realized by using a camera of the electronic device to obtain a series of images of an object. Based on an analysis of the images, a desired function can be implemented.

According to one aspect of the disclosure, a method of controlling an electronic device that includes a display device arranged on a first side of the electronic device, and a first optical device configured to capture optical data is provided. The method includes: placing an object over the first optical device so as to at least partially block ambient light from the first optical device; based on data captured by the first optical device, assigning as an input to the electronic device the detected object; and equating the assigned input to a predetermined function of the electronic device.

According to one aspect of the disclosure, the method includes performing at least one of the placing, detecting or equating steps while the electronic device is underwater.

According to one aspect of the disclosure, the method includes determining the electronic device is underwater based on signal distortion detected in raw touch data from a touch screen of the electronic device.

According to one aspect of the disclosure, the method includes using a humidity sensor to determine when the electronic device is underwater.

According to one aspect of the disclosure, the predetermined function corresponds to a press and/or release event or a motion command.

According to one aspect of the disclosure, the predetermined function is at least one of a camera shutter button function or a navigation function.

According to one aspect of the disclosure, placing the object comprises performing a scissor action with two fingers in front of the first optical device.

According to one aspect of the disclosure, placing the object includes swiping the object over the first optical device.

According to one aspect of the disclosure, swiping the object comprises blocking light from impinging on the first optical device.

According to one aspect of the disclosure, detecting the object as an input comprises comparing a plurality of sequential images to one another to determine a direction of the swipe relative to the electronic device.

According to one aspect of the disclosure, the first optical device comprises a photographic camera.

According to one aspect of the disclosure, the method includes arranging a light source relative to the first optical device to provide a minimum level of light to the first optical device when the first optical device is in an unblocked state.

According to one aspect of the disclosure, the predefined function comprises manipulating image data in the electronic device.

According to one aspect of the disclosure, manipulating image data comprises at least one of storing image data in memory of the electronic device as a photographic image or scrolling an image or a menu displayed on the display device.

According to one aspect of the disclosure, a portable electronic device includes: a touch screen input device arranged on a first side of the portable electronic device; a first optical device operative to capture optical data; a processor and memory; and logic stored in said memory and executable by the processor, said logic including logic that detects an alternate input mode of the electronic device; logic that detects placement of an object over the first optical device; logic that detects as an input to the electronic device the object; and logic that when in the alternate input mode equates the detected input to a predetermined function of the electronic device.

According to one aspect of the disclosure, the device includes a humidity sensor operative to determine when the electronic device is underwater, wherein the logic that detects the alternate input mode bases the detection on an output of the humidity sensor.

According to one aspect of the disclosure, the device includes logic that determines the electronic device is underwater based on signal distortion detected in raw touch data from the touch screen input device.

According to one aspect of the disclosure, the predetermined function corresponds to a press and/or release event or a motion command.

According to one aspect of the disclosure, the predetermined function is at least one of a camera shutter button function or a navigation function.

According to one aspect of the disclosure, the logic that detects placement includes logic that equates a scissor image in front of the first optical device as an input command.

According to one aspect of the disclosure, the logic that detects placement includes logic that equates swiping the object over the first optical device as an input command.

According to one aspect of the disclosure, the logic that equates swiping includes logic that equates blocking light from impinging on the first optical device as an input command.

According to one aspect of the disclosure, the logic that detects the object as an input comprises logic that compares a plurality of sequential images to one another to determine a direction of the swipe relative to the electronic device.

According to one aspect of the disclosure, the first optical device is arranged on the first side.

According to one aspect of the disclosure, the first optical device is arranged on a second side opposite the first side.

According to one aspect of the disclosure, the first optical device comprises a photographic camera of the electronic device.

According to one aspect of the disclosure, the device includes a light source arranged relative to the first optical device to provide a minimum level of light to the first optical device.

According to one aspect of the disclosure, the logic that equates the detected input to a predetermined function includes logic that manipulates image data in the electronic device.

According to one aspect of the disclosure, the logic that manipulates image data comprises logic that stores image data in memory of the electronic device as a photographic image or logic that scrolls an image displayed on the display device.

To the accomplishment of the foregoing and the related ends, the device and method comprises the features hereinafter fully described in the specification and particularly pointed out in the claims, the following description and the annexed drawings setting forth in detail certain illustrative embodiments, these being indicative, however, of but several of the various ways in which the principles of the invention may be suitably employed.

Although the various features are described and are illustrated in respective drawings/embodiments, it will be appreciated that features of a given drawing or embodiment may be used in one or more other drawings or embodiments of the invention.

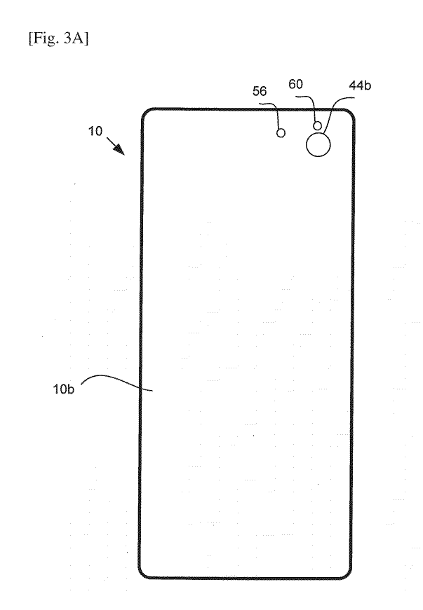

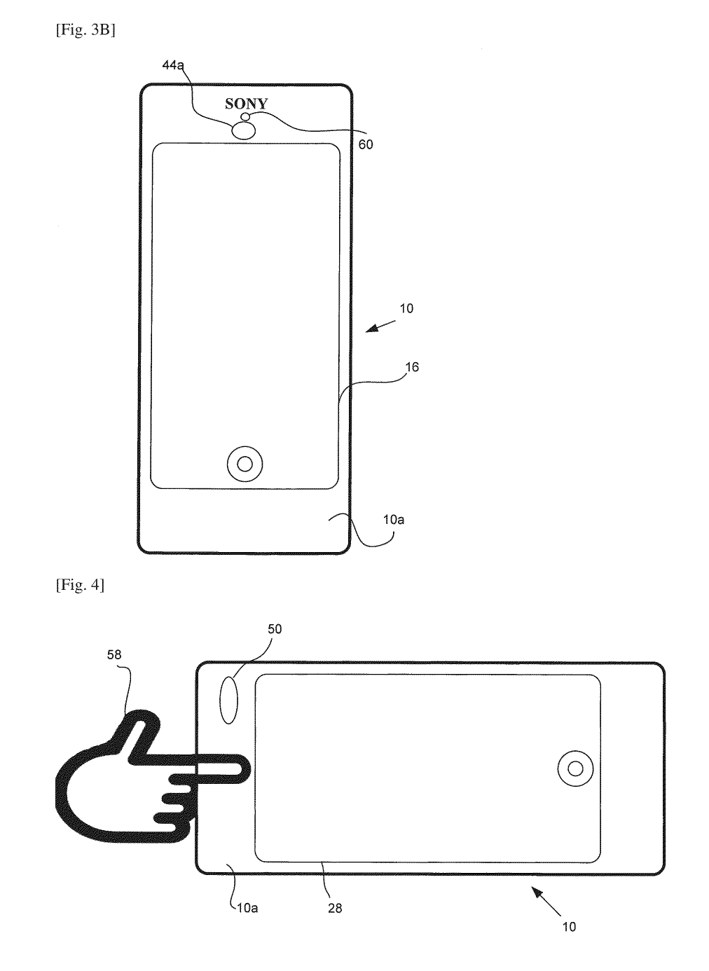

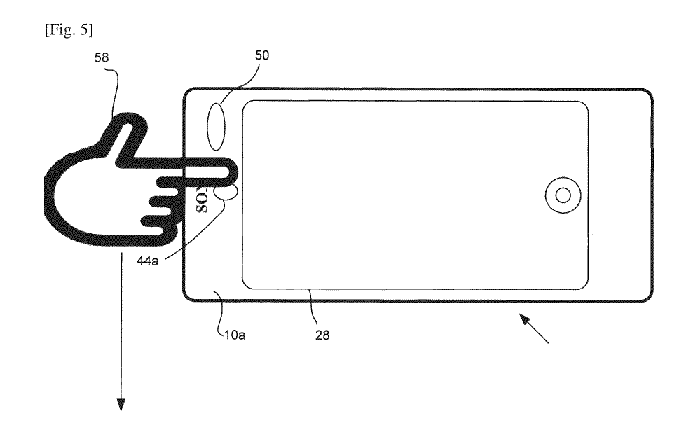

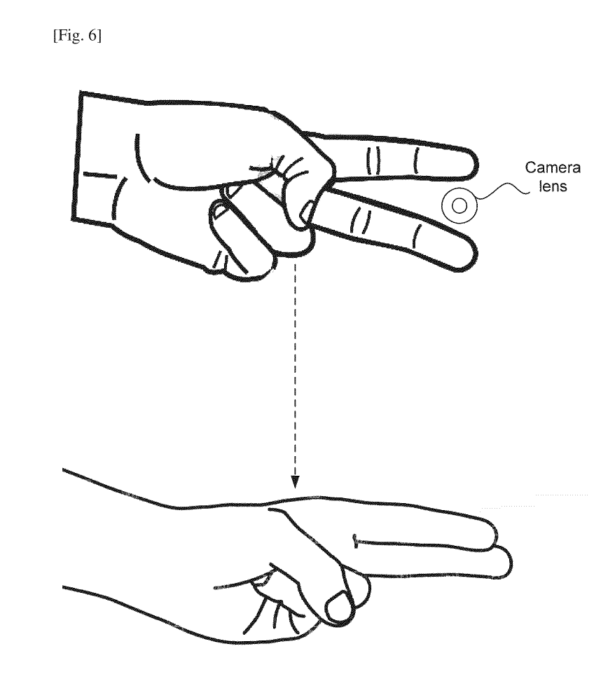

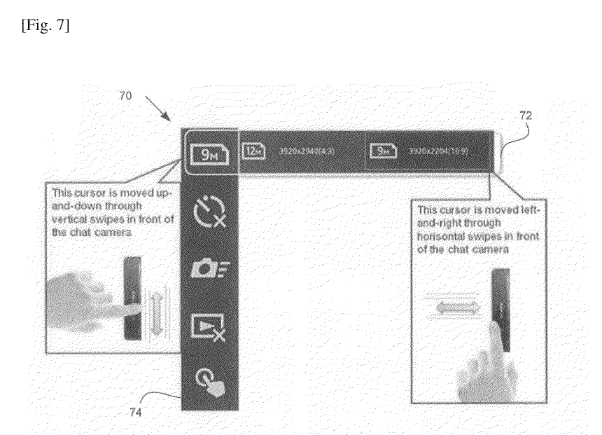

### BRIEF DESCRIPTION OF DRAWINGS

[FIG. 1] FIG. 1 is a schematic view of an electronic device in the form of a mobile telephone in use during camera mode.

[FIG. 2] FIG. 2 is a schematic block diagram of modules of an electronic device that utilizes alternate input means for controlling functions of the electronic device.

[FIG. 3] FIGS. 3A and 3B are schematic views of a front and back side, respectively, of an exemplary electronic device.

[FIG. 4] FIG. 4 is a schematic view illustrating entry of an input command in accordance with a second embodiment of the disclosure.

[FIG. 5] FIG. 5 illustrates an exemplary method of providing an input to a camera of the electronic device.

[FIG. 6] FIG. 6 is a schematic view illustrating entry of an input command in accordance with a third embodiment of the disclosure.

[FIG. 7] FIG. 7 is a schematic view illustrating implementation of the method to simulate navigation functionality in accordance with the disclosure.

### DESCRIPTION OF EMBODIMENTS

Embodiments will now be described with reference to the drawings, wherein like reference numerals are used to refer to like elements throughout. It will be understood that the figures are not necessarily to scale. Features that are described and/or illustrated with respect to one embodiment may be used in the same way or in a similar way in one or more other embodiments and/or in combination with or instead of the features of the other embodiments.

Described below in conjunction with the appended figures are various embodiments of an apparatus and a method for providing inputs to an electronic device when a conventional means for providing inputs is inoperative, e.g., a touch screen is inoperative when the electronic device is underwater, or when an alternate input means is desired. While embodiments in accordance with the present disclosure relate, in general, to the field of electronic devices, for the sake of clarity and simplicity most embodiments outlined in this specification are described in the context of mobile phones. It should be appreciated, however, that features described in the context of mobile phones are also applicable to other electronic devices.

Electronic devices that include cameras, such as mobile phones, generally include a light sensor for detecting an amount of ambient light. Based on the detected ambient light, the electronic device, for example, may vary a brightness of a display. Similarly, camera-based electronic devices also typically include a proximity sensor for detecting when an object is near/far of a surface of the electronic device. If the proximity sensor detects that an object is in close proximity to the electronic device, certain actions may be taken, e.g., ringer volume may be decreased, the display may be turned off to conserve battery power, and/or the touch panel may be disabled to prevent unwanted touch events, etc.

Electronic devices that include cameras, such as mobile phones, also typically include two cameras, e.g., a camera arranged on the same side as a display device of the electronic device (a chat camera) and a camera arranged on a side opposite the display device (a main photographic camera). Analysis of the data captured by these cameras also can be interpreted as an input, e.g., a press and/or release event, a navigation input, a scroll command, etc.

For example, placement of the object, such as the user's finger, over or in front of the chat camera or the main photographic camera will result in blocking part or all of the light captured by the respective camera. Detection of the blocked light and/or detection of a pattern of blocked light can be used to provide a number of different control functions, including, for example, image scrolling, navigation functions, etc. Further details regarding the inventive features will be discussed in more detail below.

Referring to FIG. 2, schematically shown is an exemplary electronic device in the form of a mobile phone 10 in accordance with the present disclosure. The electronic device 10 includes a control circuit 18 that is responsible for overall operation of the electronic device 10. For this purpose, the control circuit 18 includes a processor 20 that executes various applications, such as an alternate user input function 22 that carries out tasks that enable robust user input to the electronic device when the electronic device's touch screen is inoperative as described in greater detail below. As indicated, the alternate user input function 22 may be implemented in the form of logical instructions that are executed by the processor 20.

The processor 20 of the control circuit 18 may be a central processing unit (CPU), microcontroller or microprocessor. The processor 20 executes code stored in a memory (not shown) within the control circuit 18 and/or in a separate memory, such as a memory 24, in order to carry out operation of the electronic device 10. The memory 24 may be, for example, one or more of a buffer, a flash memory, a hard drive, a removable media, a volatile memory, a non-volatile memory, a random access memory (RAM), or other suitable device. In a typical arrangement, the memory 24 includes a non-volatile memory for long term data storage and a volatile memory that functions as system memory for the control circuit 18. The memory 24 may exchange data with the control circuit 18 over a data bus. Accompanying control lines and an address bus between the memory 24 and the control circuit 18 also may be present. The memory 24 is considered a non-transitory computer readable medium.

The electronic device 10 may include communications circuitry that enables the electronic device 10 to establish various wireless communication connections. In the exemplary embodiment, the communications circuitry includes a radio circuit 26. The radio circuit 26 includes one or more radio frequency transceivers and an antenna assembly (or assemblies). The electronic device 10 may be capable of communicating using more than one standard. Therefore, the radio circuit 26 represents each radio transceiver and antenna needed for the various supported connection types. The radio circuit 26 further represents any radio transceivers and antennas used for local wireless communications directly with an electronic device, such as over a Bluetooth interface.

The electronic device 10 is configured to engage in wireless communications using the radio circuit 26, such as voice calls, data transfers, and the like. Data transfers may include, but are not limited to, receiving streaming content, receiving data feeds, downloading and/or uploading data (including Internet content), receiving or sending messages (e.g., chat-style messages, electronic mail messages, multimedia messages), and so forth.

Wireless communications may be handled through a subscriber network, which is typically a network deployed by a service provider with which the user of the electronic device 10 subscribes for phone and/or data service. Communications between the electronic device 10 and the subscriber network may take place over a cellular circuit-switched network connection. Exemplary interfaces for cellular circuit-switched network connections include, but are not limited to, global system for mobile communications (GSM), code division multiple access (CDMA), wideband CDMA (WCDMA), and advanced versions of these standards. Communications between the electronic device 10 and the subscriber network also may take place over a cellular packet-switched network connection that supports IP data communications. Exemplary interfaces for cellular packet-switched network connections include, but are not limited to, general packet radio service (GPRS) and 4G long-term evolution (LTE).

The cellular circuit-switched network connection and the cellular packet-switched network connection between the electronic device 10 and the subscriber network may be established by way of a transmission medium (not specifically illustrated) of the subscriber network. The transmission medium may be any appropriate device or assembly, but is typically an arrangement of communications base stations (e.g., cellular service towers, also referred to as “cell” towers). The subscriber network includes one or more servers for managing calls placed by and destined to the electronic device 10, transmitting data to and receiving data from the electronic device 10, and carrying out any other support functions. As will be appreciated, the server may be configured as a typical computer system used to carry out server functions and may include a processor configured to execute software containing logical instructions that embody the functions of the server and a memory to store such software and related data.

Another way for the electronic device 10 to access the Internet and conduct other wireless communications is by using a packet-switched data connection apart from the subscriber network. For example, the electronic device 10 may engage in IP communication by way of an IEEE 802.11 (commonly referred to as WiFi) access point (AP) that has connectivity to the Internet.

The electronic device 10 further includes a display 16 for displaying information to a user. The displayed information may include the second screen content. The display 16 may be coupled to the control circuit 18 by a video circuit 30 that converts video data to a video signal used to drive the display 16. The video circuit 30 may include any appropriate buffers, decoders, video data processors, and so forth.

The electronic device 10 may further include a sound circuit 32 for processing audio signals. Coupled to the sound circuit 32 are a speaker 34 and a microphone 36 that enable a user to listen and speak via the electronic device 10, and hear sounds generated in connection with other functions of the device 10. The sound circuit 32 may include any appropriate buffers, encoders, decoders, amplifiers and so forth.

The electronic device 10 also includes one or more user inputs 38 for receiving user input for controlling operation of the electronic device 10. Exemplary user inputs include, but are not limited to, a touch input that overlays the display 16 for touch screen functionality, one or more buttons, motion sensors (e.g., gyro sensors, accelerometers), proximity switches, light sensors, and so forth.

The electronic device 10 may further include one or more input/output (I/O) interface(s) 40. The I/O interface(s) 40 may be in the form of typical electronic device I/O interfaces and may include one or more electrical connectors for operatively connecting the electronic device 10 to another device (e.g., a computer) or an accessory (e.g., a personal handsfree (PHF) device) via a cable. Further, operating power may be received over the I/O interface(s) 10 and power to charge a battery of a power supply unit (PSU) 42 within the electronic device 10 may be received over the I/O interface(s) 40. The PSU 42 may supply power to operate the electronic device 10 in the absence of an external power source.

The electronic device 10 includes a camera 44 for taking digital pictures and/or movies. Image and/or video files corresponding to the pictures and/or movies may be stored in the memory 24. The electronic device 10 also may include various other components. For instance, a position data receiver 46, such as a global positioning system (GPS) receiver, may be present to assist in determining the location of the electronic device 10. Yet another example is a sensor unit 50, which may include various sensors such as light sensors, proximity sensors, humidity sensors, etc., which can be used to control various parameters of the electronic device 10.

With additional reference to FIGS. 3A and 3B, front 10a and back sides 10b of an electronic device 10 in the form of a mobile telephone are shown. The front side 10a of the mobile telephone includes a display 16 and a first camera 44a. The first camera 44a may be a “chat” camera, which can be used, for example, in conjunction with a video telephone call. More specifically, the first camera 44a is arranged on the mobile telephone 10 so as to capture an image of the user as the user views the display (e.g., during a video call as the user communicates with another person). The images captured by the first camera 44a along with captured audio may be transmitted by the mobile telephone 10 to an electronic device used by the communicating party. Similarly, images and audio of the communicating party also may be captured and transmitted back to the user's mobile phone 10, the images being displayed on the display 16 and the audio being output via the speaker 34.

The back side 10b of the mobile phone 10 includes a second camera 44b, which typically is the primary photographic camera. In addition, a flash device 56 (e.g., an LED) also may be arranged on the back side 10b of the mobile phone 10, the flash device providing additional lighting for image capture in low-light conditions.

In accordance with an embodiment of the disclosure, the first camera 44a and/or second camera 44b is/are utilized to control operation of the mobile phone 10 when the conventional input means is inoperative (e.g., when the mobile phone 10 is underwater and thus the touch screen does not operate as intended), or when an alternate input means is desired. More specifically, placing or swiping an object, such as a user's finger, in front of the first camera 44a or the second camera 44b can be used to invoke various functions. Such process can operate, for example, by analyzing a difference between frames obtained by the camera 44a or 44b, the moving direction being determined based on the change in the object in a sequence of frames. An algorithm for detecting such motion can be based on simple differences between frames and an integral image (an integral image may be used for creating a smart “down-sampling” or “down-scaling” of the resulting difference frame in regards to the detected motions). Tracking the down-sampled motion frame over time enables close-range real-time gesture detection. Motion of the object can be along a surface of the camera or a predetermined distance away from the camera (e.g., 1-2 centimeters).

For example, and with reference to FIG. 4, as the object is placed over the first camera 44a, the ambient light detected by the camera will be significantly reduced or completely blocked by the finger (as a result, substantially the entire frame will be pink/orange), and as the finger is removed ambient light will again be detected by the camera. The transition from ambient light (non-pink/orange frame) to no ambient light (pink/orange frame) and/or no ambient light (pink/orange frame) to ambient light (non-pink/orange frame, coupled with the mobile phone 10 being in a particular mode, e.g., underwater mode, can be used as an input command to the mobile phone 10, e.g., a press and/or release event, a navigation input, etc.

It is noted that while the above example is described with respect to the first camera 44a, the techniques described herein are also applicable to the second camera 44b.

Placing an object over the first or second camera 44a or 44b results in a frame having a generally uniform image (e.g., in the case of a finger being placed over the camera, the resulting image may be a pink/orange frame). A difference frame then can be constructed by comparing the frame obtained when the camera is covered by the object and to the frame obtained when the camera is not covered by the object. Based on the determined difference frame, it can be determined when an object is placed over the camera and when the object is removed from the camera. Similarly, detection of a gesture, such as a “scissor” action of two fingers in front of the camera, e.g., closing and opening (or vice-versa) two fingers in front of the camera 44a or 44b, also can be detected by comparing frames. Such scissor action is illustrated in FIG. 5

In one embodiment, the control circuit 18 commands an image to be captured upon covering/shielding the camera 44a or 44b. In this regard, as a user manipulates the mobile phone to obtain an image in the view finder (e.g., display 16), the control circuit 18 stores the acquired image(s) in a temporary memory buffer (e.g., a temporary buffer within memory 24). When the user is satisfied with the image on the display, the user can cover/shield the camera 44a or 44b to indicate the image should be captured as a photograph. The control circuit 18, detecting the covering/shielding as detected by frames obtained from the camera 44a or 44b, can move the image stored in the temporary memory buffer into a user memory area for storage of photographs.

In one embodiment, the control circuit 18 of the mobile phone 10 commands an image to be captured upon removing the object from view of the camera 44a or 44b (e.g., a transition from substantially no light to light being detected by the camera). Thus, for example, a user can manipulate the phone 10 to obtain a desired image in the view finder (e.g. display 16) of the mobile phone 10. Once the desired image is in the display 16, the user can simply place his finger or fingers in from of the camera 44a or 44b and then remove the fingers, thereby generating a difference frame corresponding to removal of the object from the camera's view. A predetermined time (e.g., zero seconds to several seconds) after a difference frame corresponding to the removal of the object from the camera's view, the control circuit 18 can issue a command to capture the image. Since the image is captured after removal of the object from the camera, a buffer image need not be stored within memory of the mobile phone 10 for each captured image.

In one embodiment, the control circuit 18 detects a direction of an object 58 as the object is swiped over the camera 44a or 44b as shown in FIG. 6. For example, initially the object 58 does not cover any portion of the camera 44a or 44b. As the object 58 begins to pass over the camera 44a or 44b, the object is detected along a first portion of the captured image, while a second portion will not include the object. As the object 58 continues to move over the camera 44a or 44b, eventually all or substantially all of the frame will include the object. Further movement of the object 58 then will expose the first portion of the camera (e.g., the portion that was first blocked as the swiping motion was initiated) and thus this portion will not include the object, while the second portion will include the object. Finally, as the object 58 no longer covers the camera 44a or 44b, the object is no longer detected by the camera. Such progression of unblocked, partially blocked, fully blocked, partially blocked and unblocked can be detected by analyzing a sequence of difference frames and used to detect a swiping motion, which then can be mapped to a desired function, e.g., a joystick function, a cross-bar navigation, etc.

Further, not only can swiping motion be detected, but a direction of the swipe also can be detected. More specifically, the control circuit 18 can analyze the image data to determine which region of the captured image was initially blocked and which region is last to be blocked, which region was first to be exposed after being blocked and/or which region was last to be exposed after being blocked. Such information then can be equated to an up, down, left or right swiping motion, which can be mapped to functions of the mobile phone such as menu, enter/select, open, scroll, adjust, move left, move right, move up, move down, start recording, stop recording, finger pinch (e.g., zoom), etc.

For example, and with reference to FIG. 7, an exemplary menu 70 that may be presented on an electronic device is shown. The exemplary menu includes a first bar 72 (a horizontal bar) and a second bar 74 (a vertical bar). Each bar includes various icons representing specific functions associated with a camera of the electronic device. The exemplary first bar 72 includes selection for aspect ratio (e.g., a 4:3 aspect ratio or a 16:9 aspect ratio), while the exemplary second bar 74 includes selections for a timer (e.g., delayed image capture), a camera mode, a movie mode and a shutter button (the shutter button being used when the touch screen is active as the input).

During underwater mode or when an alternate input means is activated, a user may select between the different aspect ratios by swiping an object, such as his finger, over camera 44a or 44b in a left-to-right or right-to-left manner. Based on a difference in frames, the control circuit 18 can determine the direction of the swipe and equate the determined direction as a left or right command (and thus select the appropriate aspect ratio).

Similarly, the user may select between the various camera modes by swiping an object, such as his finger, over the camera 44a or 44b in an up-down or down-up direction. The control circuit 18 can determine the direction of the swipe based on a difference in frames and equate the determined direction as up or down command (and thus move to the next adjacent icon). Alternatively, the control circuit 18 can equate the direction of the swipe to a scrolling operation and, in appropriate circumstances, jump over several icons based on a detected speed of the swiping motion.

According to one embodiment, the first camera 44a and second camera 44b are mapped to specific functions of the mobile phone 10. For example, the first camera 44a can be mapped as an open/return/close button, navigation key or a camera shutter button, and the second camera 44b can be mapped as start/stop video recording and/or timer-based picture mode. In this manner, a user can operate the electronic device even when the touch screen is inoperative.

To assist the user in locating the first and/or second cameras while underwater, an indicator 60, such as a light emitting diode (LED) or the like, can be located adjacent to each respective cameras. When the mobile phone 10 is placed in camera mode and/or when an underwater condition is detected, the indicator 60 can be activated thereby optically indicating a location of the respective cameras. Further, the indicator 60 can be strategically placed such that it provides a defined light level for the first and/or second cameras, even when no other light is available. Then, as an object is placed over the first and/or second camera, the change in light can be detected by the respective camera.

As noted above, the alternate input means would generally be used when the conventional entry means is disabled or otherwise inoperative (e.g., when the touch screen is inoperative due to the electronic device being underwater). Activation of an “underwater mode” can be implemented, for example, via a graphical user interface of the mobile telephone 10. For example, a “settings” interface may be accessible on the mobile phone via a “settings” icon or the like. Included within the settings interface may be a soft switch for specifying normal operation or underwater operation. Manipulating the soft switch to correspond to underwater operation can change how the phone interprets data collected by the cameras 44a and 44b. Alternatively, the mobile phone 10 may automatically detect underwater operation and switch modes accordingly. For example, when a touch screen of the display 16 becomes wet, the touch screen may generate erratic signals. More specifically, the raw touch data may be analyzed, and inconsistent and/or un-even signal levels (stochastic) may be detected over the touch panel. Such inconsistent and/or un-even signal levels (referred to as signal distortion) data can provide a very distinct signal scenario, thus making a wet or underwater touch screen easy to detect. Detection of underwater operation preferably is handled, for example, by the touch panel firmware, and a notification may be sent to the host (e.g., Phones App-CPU). Based on the erratic signals, it can be concluded that the mobile phone 10 is underwater and the phone can switch to underwater mode. Yet another option would be to include a humidity sensor in the phone 10, e.g., within the sensor unit 50. Then, based on the humidity as detected by the humidity sensor, it can be concluded that the phone 10 is or is not underwater. Regardless of how underwater mode is selected, once enabled the proximity sensor 50b and/or light sensor 50a become enabled as input devices.

Although certain embodiments have been shown and described, it is understood that equivalents and modifications falling within the scope of the appended claims will occur to others who are skilled in the art upon the reading and understanding of this specification.

1. A method of controlling an electronic device that includes a display device arranged on a first side of the electronic device, and a first optical device configured to capture optical data, the method comprising:
placing an object over the first optical device so as to at least partially block ambient light from the first optical device;
based on data captured by the first optical device, assigning as an input to the electronic device the detected object; and
equating the assigned input to a predetermined function of the electronic device.

2. The method according to claim 1, further comprising performing at least one of the placing, detecting or equating steps while the electronic device is underwater.

3. The method according to claim 2, further comprising determining the electronic device is underwater based on signal distortion detected in raw touch data from a touch screen of the electronic device.

4. The method according to claim 2, further comprising using a humidity sensor to determine when the electronic device is underwater.

5. The method according to claim 1, wherein the predetermined function corresponds to a press and/or release event or a motion command.

6. (canceled)

7. The method according to claim 1, wherein placing the object comprises performing a scissor action with two fingers in front of the first optical device.

8. The method according to claim 1, wherein placing the object includes swiping the object over the first optical device.

9. The method according to claim 8, wherein swiping the object comprises blocking light from impinging on the first optical device.

10. The method according to claim 1, wherein detecting the object as an input comprises comparing a plurality of sequential images to one another to determine a direction of the swipe relative to the electronic device.

11. (canceled)

12. The method according to claim 1, further comprising arranging a light source relative to the first optical device to provide a minimum level of light to the first optical device when the first optical device is in an unblocked state.

13. (canceled)

14. (canceled)

15. A portable electronic device, comprising:
a touch screen input device arranged on a first side of the portable electronic device;
a first optical device operative to capture optical data
a processor and memory; and
logic stored in said memory and executable by the processor, said logic including logic that detects an alternate input mode of the electronic device;
logic that detects placement of an object over the first optical device;
logic that detects as an input to the electronic device the object; and
logic that when in the alternate input mode equates the detected input to a predetermined function of the electronic device.

16. The device according to claim 15, further comprising a humidity sensor operative to determine when the electronic device is underwater, wherein the logic that detects the alternate input mode bases the detection on an output of the humidity sensor.

17. The device according to claim 15, further comprising logic that determines the electronic device is underwater based on signal distortion detected in raw touch data from the touch screen input device.

18. The device according to claim 15, wherein the predetermined function corresponds to a press and/or release event or a motion command.

19. (canceled)

20. The device according to claim 15, wherein the logic that detects placement includes logic that equates a scissor image in front of the first optical device as an input command.

21. The device according to claim 15, wherein logic that detects placement includes logic that equates swiping the object over the first optical device as an input command.

22. The device according to claim 21, wherein the logic that equates swiping includes logic that equates blocking light from impinging on the first optical device as an input command.

23. The device according to claim 15, wherein the logic that detects the object as an input comprises logic that compares a plurality of sequential images to one another to determine a direction of the swipe relative to the electronic device.

24. (canceled)

25. (canceled)

26. The device according to claim 15, wherein the first optical device comprises a photographic camera of the electronic device.

27. The device according to claim 15, further comprising a light source arranged relative to the first optical device to provide a minimum level of light to the first optical device.

28. (canceled)

29. (canceled)
